(19) United States
(12) Patent Application Publication
(10) Pub. No.: US 2023/0153178 A1
(43) Pub. Date: May 18, 2023

(54) SYSTEM AND METHOD FOR STANDARDIZED PROVIDER INSTANCE INTERACTION

(71) Applicant: Grid.ai, Inc., New York, NY (US)

(72) Inventors: Luca Antiga, New York, NY (US); Richard Izzo, New York, NY (US); Sherin Chacko Thomas, New York, NY (US)

(21) Appl. No.: 17/988,983

(22) Filed: Nov. 17, 2022

Related U.S. Application Data
(60) Provisional application No. 63/280,500, filed on Nov. 17, 2021.

(51) Int. Cl. G06F 9/54; G06F 9/445

(52) U.S. Cl. CPC G06F 9/542; G06F 9/44505

(57) ABSTRACT

Variants of the system can include a set of providers, a set of configurations, a coordination system, and an event store. The system functions to coordinate between different third party services through the providers, and/or make different third party services interoperable with each other without substantial manual integration work.

### CROSS-REFERENCE TO RELATED APPLICATIONS

This application claims the benefit of U.S. Provisional Application No. 63/280,500 filed 17 Nov., 2021, each of which is incorporated in its entirety by this reference.

### TECHNICAL FIELD

This invention relates generally to the machine learning field, and more specifically to a new and useful configuration and orchestration in the machine learning field.

### BRIEF DESCRIPTION OF THE FIGURES

FIG. 1 is a schematic representation of a variant of the system and associated components.

FIG. 2 is a flowchart representation of a variant of the method.

FIG. 3 is a schematic representation of a variant of the system.

FIG. 4 is a schematic representation of a second variant of the system.

FIG. 5 is a flowchart representation of an example of the method.

FIG. 6 is a schematic representation of a variant of the method.

FIG. 7 is an example of a provider.

FIG. 8 is an example of a provider and base class.

FIG. 9 is an example of a configuration, including a set of provider specifications and a set of provider connections.

FIG. 10 is an example of the system and associated components.

FIG. 11 is an example view of a graphical provider instance interaction interface.

FIG. 12 is an illustrative representation of configurations.

FIG. 13 is an illustrative example of determining a configuration.

FIG. 14 is an illustrative representation of provider instance properties.

FIG. 15 is an illustrative representation of provider instances.

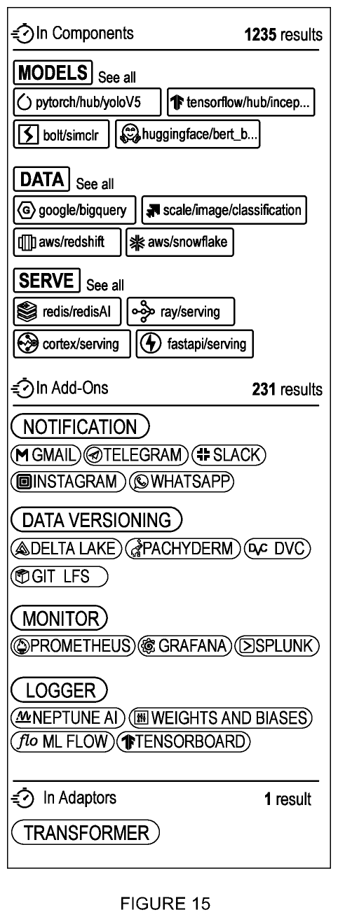

### DETAILED DESCRIPTION

The following description of embodiments of the invention is not intended to limit the invention to these embodiments, but rather to enable any person skilled in the art to make and use this invention.

### 1. Overview.

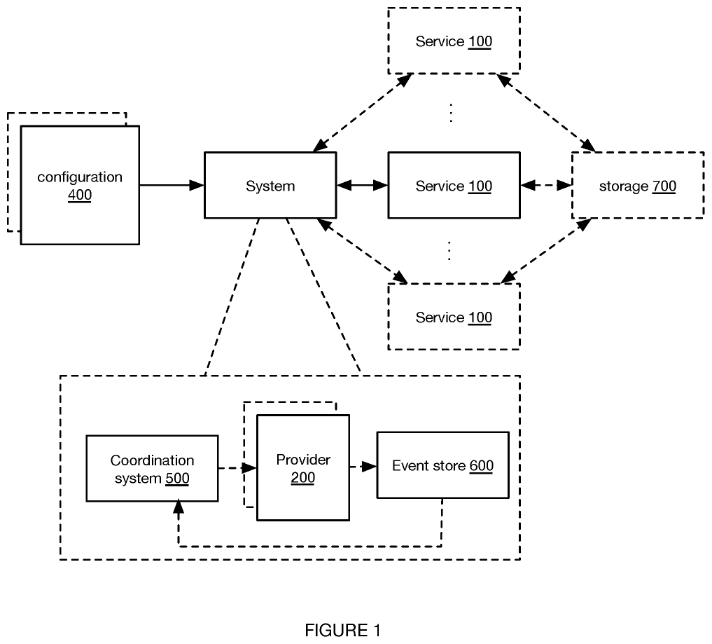

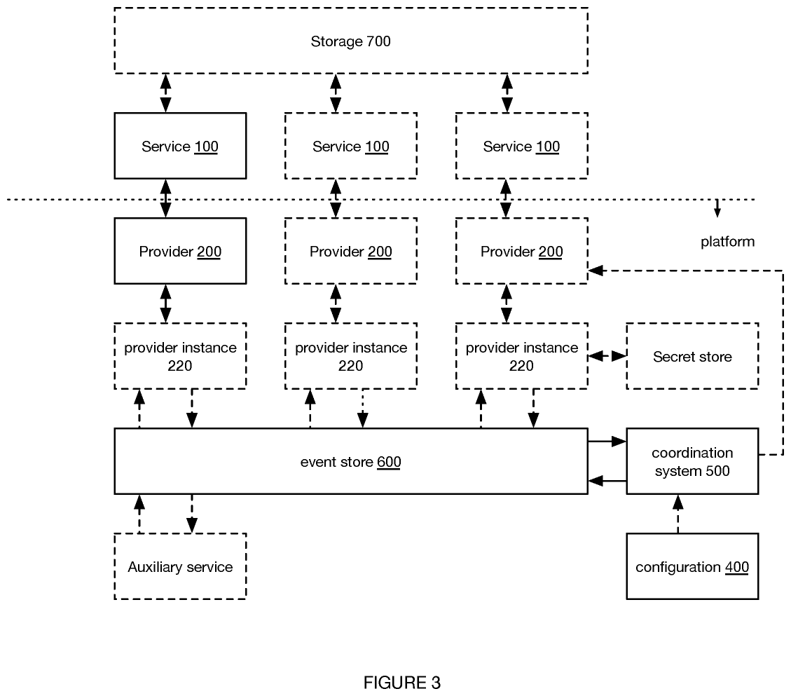

As shown in FIG. 1 and FIG. 3, variants of the system can include a set of providers 200, a set of configurations 400, a coordination system 500, and an event store 600. The system can be used with a set of services 100, storage 700, and/or any other suitable element. The system functions to coordinate between different third party services and/or make different third party services interoperable with each other, without substantial manual integration work.

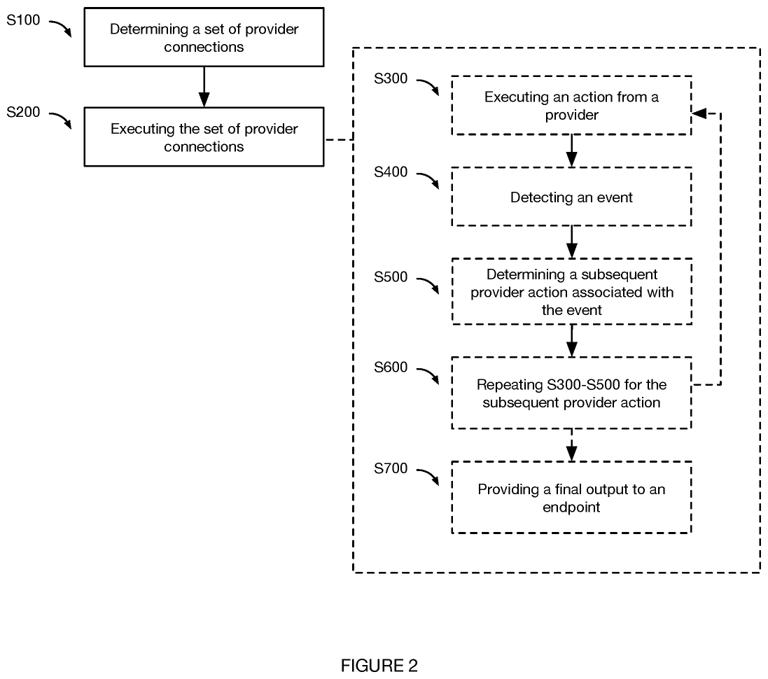

As shown in FIG. 2, variants of the method can include: determining a configuration S100 and executing the configuration S200. Executing the configuration S200 can include: optionally initializing the composition, executing an action S300, detecting an event S400; determining a subsequent provider action associated with the event S500, optionally repeating S300-S500 for the subsequent provider action S600, and optionally providing an output to an endpoint S700.

In an example, the system can include: a set of providers, each associated with a different service 100 (e.g., third party service); a coordination system 500; and an event store 600. Each provider can define a set of provider parameters (e.g., configuration parameters, traits, etc.), a set of actions, and a set of events. The set of configuration parameters can be used to set up (e.g., initialize, provision, etc.) and/or operate an instance (e.g., third party instance) on the service associated with the provider. The actions can be associated with calls, processes, and/or other actions that can be taken on the service. The events can be associated with responses, instance states (e.g., third party instance states), and/or other events generated by or based on the service. In a specific example, one or more of the providers can be associated with a base class (e.g., standard base class), wherein the base class is associated with a set of required traits, actions, and/or events. Additionally or alternatively, the base class can include provisioning instructions, instructions (e.g., code, machine instructions) on how to interact with the coordination system, event store, and/or other system element, and/or include other shared instructions.

The system can be used with a configuration, which defines the (third party) services that a user wishes to interoperate. The configuration can include a set of provider specifications for a set of services and a provider composition. The set of provider specifications can include, for each service: a provider identifier for the respective service and a set of values for configuration parameters of the identified provider. The provider composition can include a set of events (from the set of providers) associated with (e.g., connected to) a set of actions (from the set of providers), wherein detection of an event triggers the connected action.

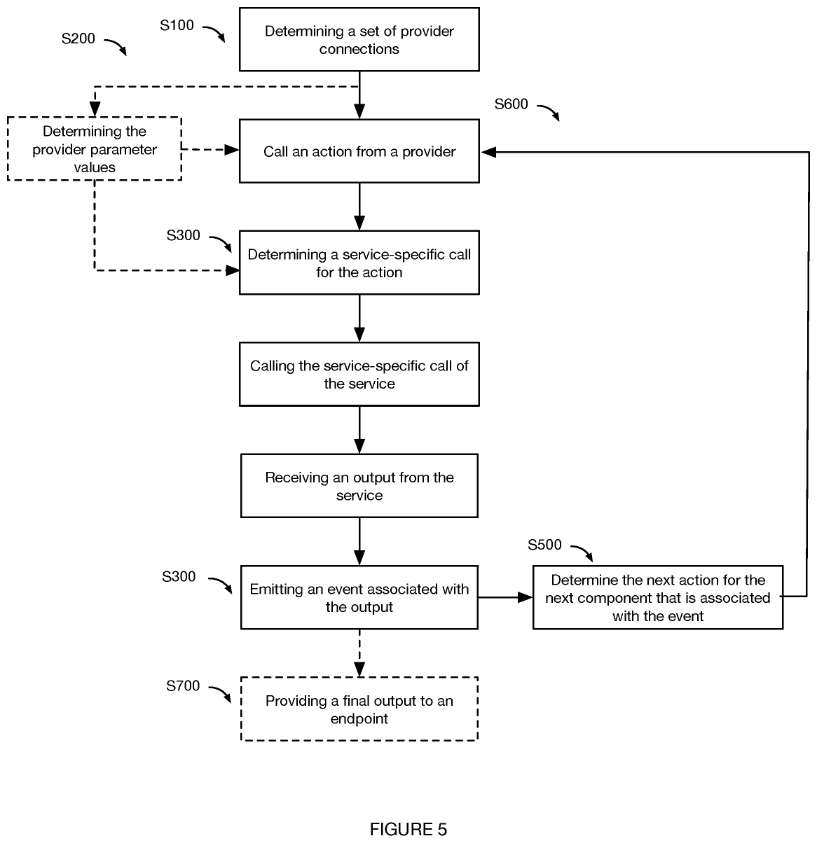

In operation, the system can: determine the configuration and/or provider composition (e.g., receive the configuration from a user); call at least one action from a provider specified in the composition, wherein the provider implements the associated service-specific call on the associated service; detect an event (e.g., from a first provider specified in the composition; such as by monitoring a shared event store); determine an action (e.g., from a second provider) that is associated with the event within the configuration (e.g., connected to the event within the provider composition); and call the action from the second provider (e.g., example shown in FIG. 5). When an action is called, the respective provider can translate the action into a service-specific action (e.g., third party service-specific call) and implement the service-specific action on the service. The service can execute the service-specific action, and can optionally access (e.g., read and/or write) to shared storage (e.g., passed to the service by the respective provider). The providers can also receive service responses, query the service instance state, and/or otherwise generate events associated with the respective service, wherein the events can be exposed (e.g., written, published, etc.) to a shared event store (e.g., event stream, event queue, event buffer, etc.). The method can be performed by the coordination system 500, individual providers 200, and/or by other elements. In variants, the system can optionally set up (e.g., initialize, provision, etc.) a set of provider instances 220 for each provider identifier within the configuration and/or set up (e.g., initialize, provision, etc.) a set of third party instances for each provider instance (e.g., using stored user credentials to access the third party services), wherein the provider instances 220 generate the events, implement the actions, and/or otherwise interact with the respective third party instance.

In an illustrative example, a configuration can identify an image data source provider, a first and second object detector provider connected to the image output of the image data source provider, a use case provider connected to the tensor outputs of the first and second object detector providers, and a model service provider connected to the use case provider. During execution, the coordination system: calls the data source (associated with the image data source provider) to provide images (e.g., to platform memory or external memory); in response to successful image provision, calls the first and second object detectors (associated with the first and second object detector providers) with references to the images; in response to successful object detection, calls the use case service (associated with the use case provider) with references to the object detections; and in response to successful use case processing, calls the model service (associated with the model service provider) with references to the use case output.

However, the system can be otherwise configured, and the method can be otherwise performed.

### 2. Technical Advantages.

Variants of the technology for standardized provider instance interaction can confer several benefits over conventional systems and methods.

First, the technology can enable facile composition of previously incompatible services into a unitary custom workflow by facilitating communication between the disparate services using a set of standard event and action objects. In particular, compatibility between disparate services can be enabled by translating platform action objects into service-specific actions (e.g., calls) and by translating service-specific event objects into platform event objects, using a provider specific to a given service. In variants, this standardization can be further enabled by using provider instance types (e.g., base classes), wherein providers supporting different provider instance types must include translations for a predetermined set of actions and/or events specific to the provider instance type.

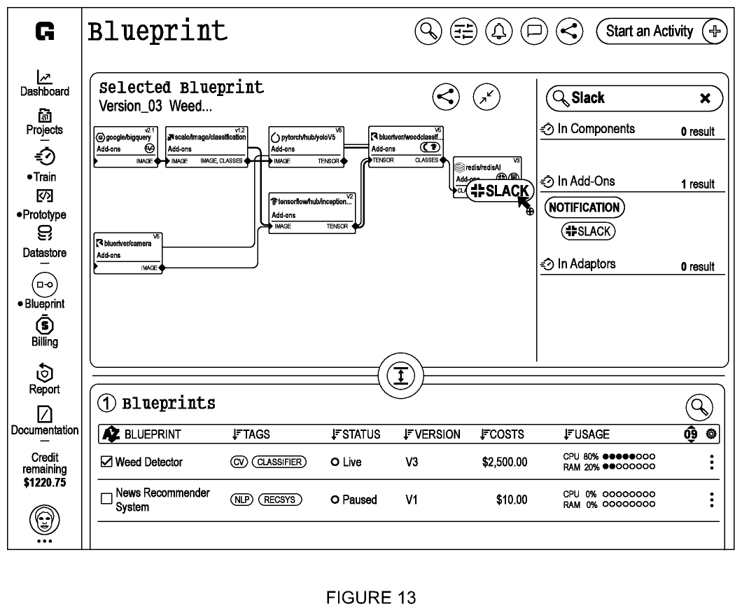

Second, variants of the technology can enable a user to set up complex interactions between disparate third-party services without a developer, without deep understanding of the service's APIs, and/or with little or no specialized manual engineering work (e.g., with little or no development operations experience or skills, such as feature engineering, library-building, model deployment, calibration tooling, versioning, job scheduling, compute resource management, or data warehousing, etc.). In variants, can be achieved by leveraging a no-code, low-code, or single line of code interface, wherein each visual or code object defined in the interface can be associated with a provider instance and provider that abstract away the service-specific code (e.g., example shown in FIG. 13). In variants, this can be achieved by creating a composition platform that is opinionated on how the system is described, provisioned, configured, and managed, but is agnostic to what hardware and/or service the composition is provisioned on. In variants, this can be achieved by exposing a simplified action and/or event syntax for each service (e.g., via the respective provider). In embodiments, this simplified syntax can reduce or eliminate the need for the user to program the composition using disparate service-specific syntaxes. In variants, the resultant composition can be executed with a single user action (e.g., a single click to run multiple services), with little or no manual monitoring or coding after deployment.

Third, variants of the technology can enable a user to set up (e.g., provision, initialize, etc.) instances on different third-party services with little to no specialized engineering work. For example, a user can specify the parameter values for the services they would like to use (e.g., without writing service-specific code), and the respective providers can automatically set up the instances according to the parameter definitions (e.g., according to a set of instructions specific to the service). The providers can additionally or alternatively use the custom parameter values when executing the service-specific action objects and/or managing the service-specific event objects.

Fourth, variants of the system and method can automatically orchestrate inter-service operation by monitoring for events output by a given provider (e.g., associated with a first service) and automatically calling the associated subsequent action for another provider (e.g., associated with a second service).

Fifth, variants of the system and method can enable data scientists to work locally at scale, define complex model development flows using preferred tools without managing the challenges of DevOps, access a fully configured multi-provider instance system in seconds, and generate a configuration describing the fully configured multi-provider instance system in a machine-readable format (e.g., generate source code, generate a human and/or machine-readable structured document, etc.). The generated configuration can optionally enable data scientists to include any additional logic necessary for configuring the multi-provider instance system. In a first use case, the configuration can be transformed by another program to conditionally include specific services depending on the desired results. In a second use case, the configuration can be templated for different data scientists to specify a minimal set of inputs (e.g., user_id, password) and launch individual instances of the services for exclusive use (e.g., wherein different service instances can perform similar, but not necessarily identical, behaviors). In a third use case, the configuration can be embedded within a program that automates the instantiation and/or management of the configuration.

Sixth, variants of the system and method can provide additional user privacy and security by only orchestrating inter-service operation based on metadata (e.g., secrets represented by API keys for third party services, event strings, etc.) rather than directly handling (e.g., storing, routing, etc.) the data manipulated by the services.

However, further advantages can be provided by the system and method disclosed herein.

### 3. System.

The system (e.g., the platform) can include: a set of providers 200, a set of configurations 400, a coordination system 500, and an event store 600. However, the method can be performed with any other suitable system. The system can be used with a set of services 100, storage 700, and/or any other suitable element.

The system can be used with a set of services 100, which functions to receive service-specific action objects (e.g., calls), execute service-specific action objects, output service-specific event objects, optionally output artifacts, and/or perform other functions. Each service of the set can be associated with one or more functionalities (e.g., functional class, standard provider class, provider instance types). Examples of functionalities can include: data provision (e.g., data storage), model storage (e.g., model repositories), model training, model serving, cloud infrastructure services (e.g., orchestration services, hardware services, etc.), cloud computing providers, collaboration, notifications, data versioning, data logging, workflow monitoring, and/or other functionalities. Examples of supported services can include: data sources (e.g., Google BigQuery, AWS Redshift, AWS Snowflake, Scale AI Image Classification, sensors, etc.), database management systems (e.g., MySQL, PostgreSQL, etc.), model repositories (e.g., Hugging Face, etc.), model building services or frameworks (e.g., PyTorch Lightning, Tensorflow, etc.), model training services (e.g., Grid train), container orchestration services (e.g., Kubernetes, etc.), computing providers (e.g., AWS, Microsoft Private Cloud, IBM Smart Cloud, etc.), model serving services (e.g., RedisAl, Ray Serve, Cortex, FastAL etc.), collaboration and/or notification systems (e.g., Gmail, Telegram, Slack, Instagram, WhatsApp, etc.), data versioning services (e.g. Delta Lake, Pachyderm, DVC, Git LFS, etc.), loggers (e.g., Neptune AI, Weights & Biases, MLflow, TensorBoard, etc.), monitoring services (e.g., Prometheus, Grafana, Splunk, etc.), and/or any other suitable service.

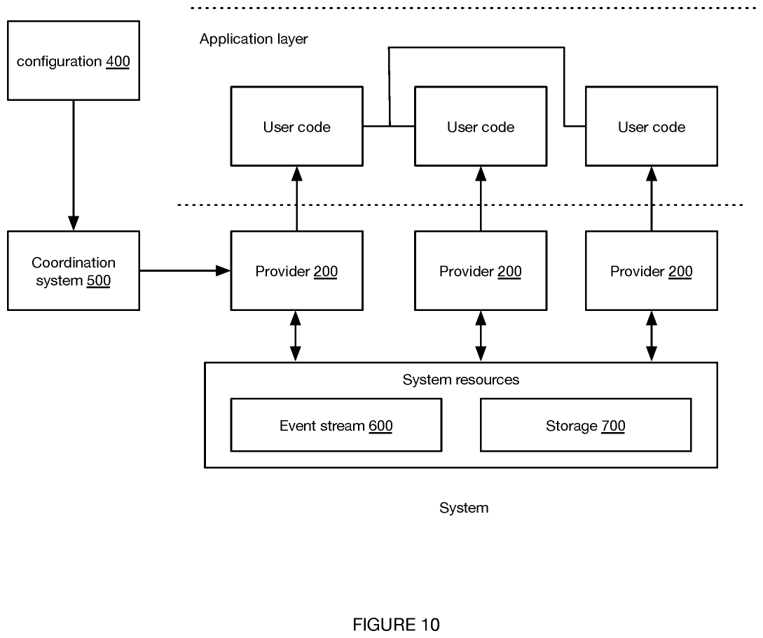

Each service can be a product, a product suite, a product feature, a product functionality, a product subfunctionality, a block of code (e.g., example shown in FIG. 10), and/or any other suitable service.

Each service can be provided by a third-party entity (e.g., Amazon AWS, etc.), non-third-party entity (e.g., the platform, etc.), and/or any other suitable entity. A third-party entity and/or a non-third-party entity can provide one service, multiple services (e.g., AWS can provide Redshift, Snowflake, and SageMaker), and/or any other suitable number of services. Different services in the set can be provided by different entities (e.g., users, organizations, research groups, etc.) and/or the same entity.

Each service can have its own set of service-specific interactions (e.g., service-specific API calls, publication streams, subscription streams, etc.), require different inputs for said interactions, require different formats (e.g., syntax) for said interactions, provide different outputs (e.g., in different formats, etc.), provide different events (e.g., in different formats, at different abstraction levels, with different semantic meaning, etc.), require different computing environments, require different monitoring methods, and/or otherwise differ. Alternatively, one or more aspects of one or more services can be the same.

The service inputs can define how an instance of the service is provisioned, configured, initialized, deployed, managed, shut down, and/or otherwise operated. Service inputs can be derived from, the same as, or different from provider inputs. Examples of service inputs can include: provisioning parameters, service configuration parameters, initialization parameters, deployment parameters, management parameters, and/or other parameters. Illustrative examples of service inputs can include: user account information (e.g., login information, tokens, etc.), machine configurations (e.g., number of machines to initialize, which type of machine to initialize, etc.), the storage identifier (e.g., URL, filepath, name, etc.), number of epochs to run, and/or any other suitable input. The input values can be determined from the configuration, be specified by the provider, be manually specified, be dynamically determined (e.g., determined by another provider, determined from a global variable shared between providers, determined by an external source, determined by another service, etc.), and/or otherwise determined.

The service events can provide insight into the state of a service instance or a component or process thereof. Service events can be derived from, the same as, or different from provider events. The service event is preferably generated by the service, but can additionally or alternatively be generated by the provider for the service, by a monitoring system, and/or by any other suitable component. Examples of service events can include: started, running, completed, paused, failed, output generated, number of runs left, amount of compute being used (e.g., memory, processing power, electrical power, etc.), and/or any other suitable service state. Service events can be provided to the respective provider, be provided to the event store 600, be stored in the storage 700, and/or be otherwise managed.

The service outputs are preferably data objects, metadata, or other artifacts produced through service instance execution (e.g., images, models, etc.). Service outputs and service events are preferably different; alternatively, outputs can be events or vice versa. Service outputs are preferably not provided to the platform (e.g., the platform is blind to the service outputs, which can maintain user confidentiality and security over their composition's outputs), but can alternatively be provided to the platform. Service outputs can be stored by the service, stored to the storage 700, returned to the respective provider, and/or otherwise managed.

In operation, each service can generate one or more service instances. In variants, the service instances can be the functional building blocks that the system composes (e.g., via the respective providers), and provide the actual functionality (e.g., training, serving, data ingestion, third party service integrations, etc.) that the user wishes to coordinate. Each service instance is preferably managed by one or more provider instances and/or provider within the system, but can additionally or alternatively be managed by the user (e.g., using a set of service-specific scripts, etc.), or be otherwise managed. The service instance is preferably configured using the provider parameter values for the associated provider instance, but can alternatively be configured using user-provided values, values provided by another service, and/or using any other suitable set of values. The service instance is preferably configured using a set of user credentials (e.g., associated with the provider instance, composition, and/or the composition's configuration; stored within the secret store; etc.), but can alternatively be configured using a set of platform credentials (e.g., shared across multiple users), and/or using any other suitable set of credentials. In variants, the user associated with the composition can separately access the service instances (e.g., using the user credentials). The service instance preferably executes independently, but can additionally or alternatively execute in coordination with other services. In the latter variant, the services can communicate with each other via their native mechanisms (e.g., their native integrations, application layers, etc.); alternatively, the services can communicate via the system (e.g., platform), wherein data can be published to an on-platform shared store accessible by both systems (and/or respective providers). The service instances are preferably not wrapped, but can alternatively be wrapped.

However, the services can be otherwise defined.

The system can be used with storage 700, which functions to store service outputs, and can itself be a service. The storage 700 is preferably separate from the platform, but can alternatively be part of the platform (e.g., be platform storage). The storage 700 can be identified by a storage identifier, wherein the storage identifier is used by the platform (e.g., the coordination system 500), the providers, and/or the services to access data stored within the storage 700. Examples of the storage identifier can include: a filepath, a URL, a service identifier (e.g., for a data storage service) and unique storage identifier for the service, and/or any other suitable storage identifier. Each composition (e.g., set of connected services) can be associated with one or more stores 700.

The system can optionally be used with a secret store that stores secrets. The secrets can be user secrets (e.g., cryptographic keys, API keys, user credentials, etc.), platform secrets (e.g., private keys, etc.), and/or any other suitable secret. The secret store can be part of the platform, be part of the storage 700, and/or be otherwise located. The secret store can be only accessible to the platform, be accessible to other services (e.g., wherein the other services can include the authorization and/or authentication credentials to access the secret store), and/or otherwise accessible. The secret store can be: a secure enclave, a trusted execution environment, encrypted memory, and/or other secure storage. The secret store and/or data objects therein (e.g., environment variables) can be referenced by the configuration, providers, services, and/or other entity using variable names, hashes, and/or other identifiers. For example, an API key to a third-party entity service can be represented as an environment variable referencing the API key stored in the secret store, which can enable the API key to be used without exposing the API key in cleartext. In an illustrative example, a reference to ${FOO_API_KEY} in the configuration (e.g., in a provider instance) can refer to a key value identified by the FOO_API_KEY that is stored in the secret store (e.g., entered by a user), such that the actual key value is not stored in the configuration (e.g., in the configuration's YAML document). The FOO_API_KEY can be resolved by the system once the configuration is submitted for execution.

The system functions to implement one or more compositions of one or more service instances for one or more services. The composition can additionally or alternatively include one or more providers and/or instances of the providers (e.g., the provider instances) for each of the services and/or service instances within the composition. The system (e.g., platform, coordination system, etc.) can implement a composition by: setting up each service instance (e.g., with the respective service), coordinating inter-service interactions (e.g., by selectively triggering execution of a given service action responsive to occurrence of a predetermined event generated by another service), and/or otherwise implement a composition. The composition is preferably generated based on a single configuration, but can alternatively be generated based on multiple configurations.

The composition is preferably executed by a coordination system 500 using a set of providers 200 based on a set of configurations 400, but can additionally or alternatively be executed using any other suitable set of components.

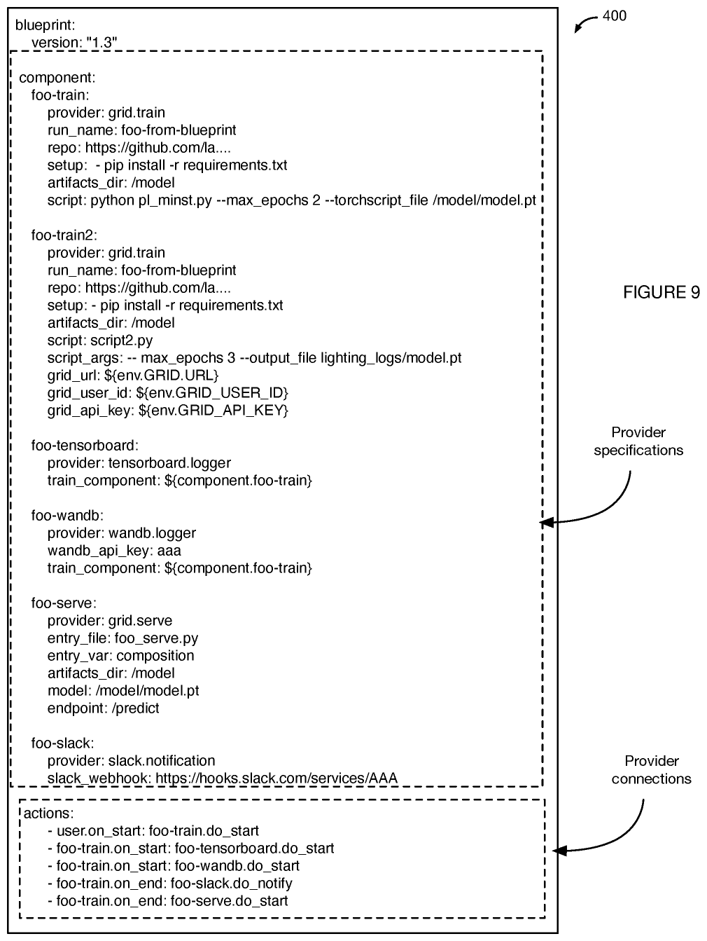

In an illustrative example, a composition can include: a system instance (e.g., system), a model training provider instance (e.g., foo-train) associated with a model training service instance, a Tensorboard logger provider instance (e.g., foo -tensorboard) associated with a Tensorboard instance, a Weights and Biases provider instance (e.g., foo-wandb) associated with a Weights and Biases instance, a Slack provider instance (e.g., foo-slack) associated with a Slack instance, and a model serving provider instance (e.g., foo-serve) associated with a model serving service instance. In operation, the platform can invoke one or more of a series of actions from the providers responsive to occurrence of an event connected to said action. For example, the system can call an action from the model training provider instance (e.g., minst-train.do_start) when the system detects a predetermined system start event (e.g., system.on_start); call an action from the weights and biases provider (e.g., foo-wandb.do_start) when a predetermined model training event is detected (e.g., foo-train.on_start); call an action from the slack provider (e.g., foo-slack.do_notify) when a predetermined model training event is detected (e.g., foo-train.on_end); and call an action from the model serving provider (e.g., foo-serve.do_start) when a predetermined model training event is detected (e.g., foo-train.on_end); example shown in FIG. 9. This can cause the composition to start a model training session, log data from the model training session (e.g., in Tensorboard and Weights and Biases), and send a notification via Slack (e.g., using a predefined webhook) and serve the model (e.g., at a predetermined endpoint) when the model training is complete.

However, the composition can be otherwise created, used, and/or configured.

The set of providers 200 (e.g., service modules) functions as an interface between the platform and the set of services. Each provider can translate service-specific event objects into standard event objects, and translate standard action objects into service-specific action objects. Each provider can optionally initialize, provision, configure, deploy, manage, start, stop, and/or otherwise interact with the associated services (e.g., wherein instances of the provider can interact with instances of the service). The provider can be used to create provider instances that are used by the system to interact with the services; alternatively, the providers themselves can be used directly to interact with the services. The provider can additionally or alternatively interact with: provider instances (e.g., on the platform), service instances (e.g., off the platform, using the provider parameter values), and/or other process instances. The provider can additionally or alternatively: compose service-specific action objects (e.g., based on the provider instance configuration; retrieve or send the requisite data to the service; etc.), call service-specific actions (e.g., using the service-specific action object, using service-specific syntax and/or logic), convert service-specific event objects into standard event objects, monitor service states (e.g., action execution progress, etc.), manage artifacts output by the service, interact with the service based on parameters specified by a provider instance, and/or otherwise interact with the service. The provider can optionally emit provider-specific events corresponding to their service instance's lifecycle (e.g., started, ended, running, epoch completed, etc.). Providers can be opinionated in how things are provisioned, or be unopionated. Providers can be stand-alone providers, or be integrated in a hierarchy of providers (e.g., wherein providers within the hierarchy can share lifecycle events). Providers can be private or public. However, the provider can perform any other suitable functionality.

In an example, a provider can be called by the system (e.g., by the coordination system, by the provider instance, etc.), wherein the system call can specify a provider action to be executed and the parameters for the provider action (e.g., the data to be processed, filepath, URL, etc.). The parameters for the provider action are preferably extracted from the configuration, more preferably from the provider instance specification within the configuration, but can additionally and/or alternatively be automatically identified, dynamically determined (e.g., based on one or more events from other providers), determined by another provider, retrieved by the platform (e.g., from an external system, from the secret store, etc.), and/or otherwise determined. Each provider can compose a service-specific action (e.g., call) corresponding to the provider action, using the parameters for the provider action, retrieve a pre-specified service-specific action, and/or otherwise determine the service-specific action. Each provider can call the service using a set of service-specific instructions (e.g., calls, actions, syntax, logic, etc.) associated with the provider action, optionally using the parameters for the provider action and/or user credentials (e.g., from the secret store), and/or otherwise cause the service to execute the service-specific action. Each provider can optionally orchestrate service instance execution. Each provider can optionally receive a response or status information from the service and generate a standard event object corresponding to the response or status. The provider can publish, write, store, or otherwise expose the standard event object to the rest of the system via the event store 600, a provider-specific channel, a composition-specific channel, and/or via any other suitable shared data stream. Each provider can optionally route any service outputs (e.g., artifacts) to a data store (e.g., storage 700) specified by the provider instance (e.g., which can be another service within the configuration); alternatively, the service can directly store outputs to the data store (e.g., without the provider functioning as an intermediary). However, each provider can be otherwise configured.

The system (e.g., platform) can include one or more providers. Each provider is preferably associated with a third-party entity, but can alternatively be associated with a plurality of third-party entities, with the platform (e.g., be a first-party provider), and/or be associated with any other suitable entity. Each provider can be associated with a single service (e.g., one provider for each service provided by each third-party entity; wherein each provider is specific to a third-party service; etc.), but can alternatively be associated with a plurality of services (e.g., one provider for all services provided by each third-party entity), or no services (e.g., a timer). Each service is preferably associated with a single provider, but can alternatively be associated with different providers. Different providers for the same service can be associated with different service functionalities, different levels of service control or interaction, and/or otherwise differ.

Examples of providers can include: a service-specific provider, a contextual provider (e.g., a provider monitoring a sensor, a timer or provider connected to a clock, etc.), a user input provider (e.g., a provider that emits events responsive to user interactions), and/or be any other suitable provider. Examples of service-specific providers can include: an AWS provider (e.g., AWS integration), a Slack provider (e.g., Slack integration), a Weights and Biases provider (e.g., Weights and Biases integration), and/or any other provider for any other suitable service.

Each provider can be authored by one entity, multiple entities (e.g., entity providing the service, users, machine learning developers, organizations, research groups, etc.), and/or any other number of entities. Each provider is preferably defined by the entity providing the service, but can additionally and/or alternatively be defined by another entity, automatically defined, and/or otherwise defined. Each provider is preferably certified on a provider registry, but can alternatively not be certified. Each provider is preferably retrieved from the provider registry, but can additionally and/or alternatively be retrieved from a third-party entity database, and/or otherwise retrieved.

The service associated with the provider can be known or unknown to the platform or user. For example, a provider can spin up a database on a compute node (e.g., wherein the platform is blind to or agnostic to where and/or how the node is provisioned), and then establishes secure tunnels (e.g., connections) from other services to the database process so that, as other provider instances do their work, they are able to persist or query some set of shared data. When the configuration instance (e.g., blueprint) is shut down (e.g., at specific time intervals for redundancy/backup; responsive to a stop event; etc.), this database could be dumped to the datastore provider instance and used elsewhere or as input for another configuration run, or be otherwise managed.

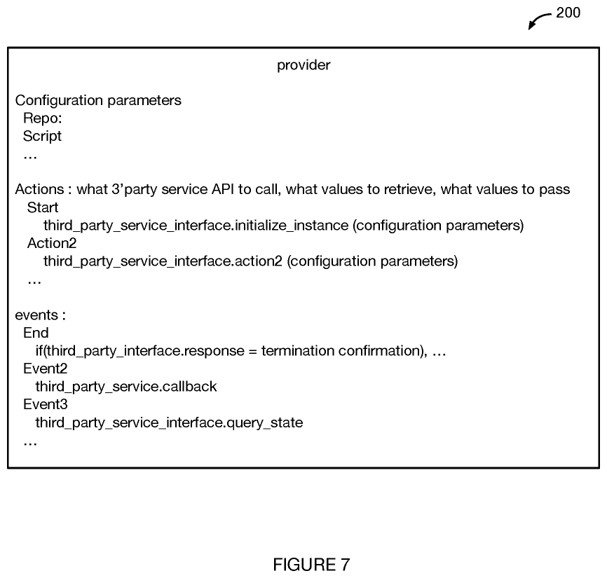

Each provider can include (e.g., define): provider logic, a set of provider parameters, a set of provider events, a set of provider actions, and/or any other suitable set of provider resources (e.g., example shown in FIG. 7). The provider events, provider actions, provider parameters, and/or any other suitable provider resource can be exposed to the system (e.g., in provider documentation) and/or coordination system, be hidden, and/or be otherwise exposed.

The provider logic functions to manage the lifecycle of the service instance associated with the provider. Examples of provider logic can include: state management logic, service orchestration logic, and/or any other suitable logic. In an example, the provider can monitor prior call completion and automatically trigger subsequent call execution when the standard action is associated with a series of service-specific action objects (e.g., calls). The provider can optionally detect and mitigate service failures. In another example, the provider can monitor the service-specific event objects output by the service when the standard event is associated with a set of service-specific outputs or results. However, the provider can include any other suitable function. The provider logic is preferably specific to the provider and/or associated service, but can alternatively be shared between providers.

The provider parameters (e.g., service parameters, traits, configuration parameters, etc.) of a provider function to represent parameters to be passed to and used by the service when interacting with the service. Each provider can be associated with one or more provider parameters. The provider parameters for the provider are preferably exposed, such that a user can assign values and/or variables to the parameters (e.g., using the configuration), but can alternatively be hidden (e.g., be a parameter that cannot be adjusted, such as a service's API endpoint identifier).

The provider parameters can be used to configure the service instance, operate the service instance (e.g., pass provider parameter values as action variable values), configure and/or operate an instance of the provider (e.g., provider instance), and/or otherwise used. For example, provider parameters can specify: a provider instance name (e.g., a locally unique name for the provider's instance), the number of machines to use, the type of machine to use, the hyperparameters to use (e.g., batch size, number of epochs, number of runs, etc.), the models to use (e.g., model filepaths, model identifiers), which credentials to use (e.g., user identifiers, API keys, etc.), which endpoints to use (e.g., where to draw data from, where to push notifications to, etc.), where to store outputs (e.g., filepaths, etc.), which scripts to use, references to other providers, provider parameters, and/or provider variables, and/or specify other service parameters. Specific examples of provider parameters can include: url, user_id, api_key, ca_cert, foo_secret, run_name, run_description, framework, repo, script, script_args, strategy, trials, datastore_name, datastore_version, datastore_mount_dir, instance_type, processes, entry_file, entry_var, requirements_file, slack_webhook, and/or any other suitable provider parameter. In an illustrative example of a reference to another provider, “foo-logger: . . . train-component: ${components.foo-train}” can assign the foo-train provider instance to the “train-component” parameter of the “foo-logger” provider instance. In another example, ${components.foo-train.artifacts_dir} can be used to pass the artifacts directory of the foo-train provider instance to another provider instance.

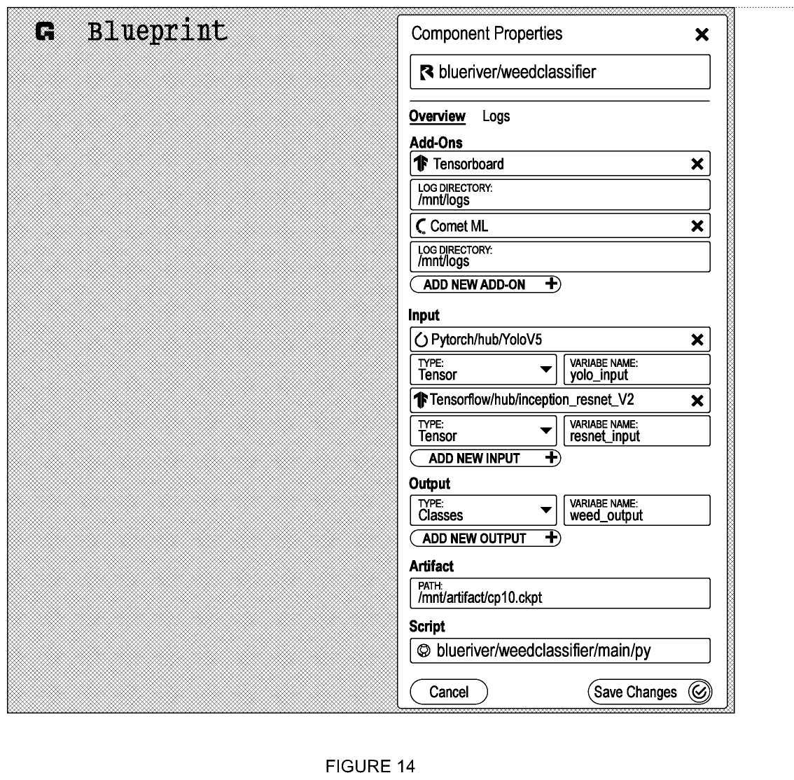

Values for the provider parameters can be specified by the configuration (e.g., in the provider specification for the given provider), inferred by examining the configuration of other providers, generated by another service (e.g., a preceding service in the configuration execution order), provided by a user, be randomly generated, and/or otherwise determined. The values can be: file references (e.g., URI, filepaths, etc.), argument values specific to the provider instance (e.g., hyperparameter values, etc.), references to another provider or instance thereof, variable names, and/or be any other value. The provider parameter values can be specific to the provider instance (e.g., example shown in FIG. 14,) or be shared. The provider parameter values can be static (e.g., fixed, predetermined, etc.), dynamic (e.g., unfixed; dynamically assigned, etc.), and/or otherwise determined. The static values can be specified by the configuration, by the provider (e.g., a service's API endpoint), and/or otherwise specified. Dynamic values can be specified by a shared variable (e.g., global variable) bound to the value to be used, determined by the coordination system (e.g., wherein the coordination system dynamically binds the value to the provider parameter when calling the provider action), and/or otherwise determined. In a first example, a logging provider can include a monitored service parameter that identifies the service that logs should be generated for, wherein the identifier for a service instance associated with a machine learning provider (e.g., determined by the machine learning provider) is bound to the monitored service parameter. In a second example, a model deployment provider can have a model parameter that identifies which model to serve, wherein the model parameter is bound to a global variable, which, in turn, is bound to a filepath specified by a model training provider. However, the values assigned to the provider parameters can be otherwise determined.

The provider events function to provide information about the service's state (e.g., the state of the service instance, service instance lifecycle, etc.), wherein the system can trigger subsequent actions (e.g., provider actions, service actions) based on occurrence of a provider event. In variants, the provider events can do so in a simplified syntax (e.g., the provider syntax). Each provider can be associated with one or more provider events, or no provider events. Each provider event can be associated with one or more service states. Each service state can be associated with one or more provider events. The provider event preferably includes metadata, but can alternatively be the output datum (e.g., the trained model) and/or any other suitable output. The metadata can include: the service instance identifier, a timestamp, other contextual parameters (e.g., epoch number, etc.), the provider instance identifier, and/or any other suitable metadata. Examples of provider events can include: start (e.g., service start confirmation), stop (e.g., service stop confirmation), executing, artifact generated, artifact stored, and/or other events indicative of a service state. Each provider in the system preferably has its own set of provider events, wherein different providers have different provider events, but can alternatively have the same set of provider events as other providers.

The provider event is preferably determined based on a service output-provider event mapping defined by the provider, but can be otherwise determined. The service output-provider event mapping can specify which provider event is associated with which service output, and/or be otherwise defined.

The provider events for the provider are preferably exposed, such that an action can be triggered based on occurrence of the provider event, but can alternatively be hidden (e.g., only used by the provider). Each provider event is preferably associated with a single possible value, but can alternatively be associated with multiple possible values (e.g., wherein coordination system can determine which action to take based on logic specified in the configuration).

The provider preferably generates one or more provider event objects for each provider event occurrence. However, the provider event objects can be generated by the coordination system, the service, by timers (e.g., in response to intervals having occurred; schedule periodic and/or delayed actions on provider instances), and/or by any other suitable component. Each provider event is preferably a singleton, but can alternatively not be a singleton. The provider event objects can be representative of service event occurrence, and/or represent any other information. The provider event objects are preferably generated by the provider, but can alternatively be generated by the service or another component. The provider event objects are preferably platform-standard (e.g., compliant with a platform syntax or protocol, etc.), but can alternatively be custom, service-specific, and/or otherwise standard or generic. The provider event objects are preferably generated based on an output from the service (e.g., a service response, a webhook event, etc.), but can alternatively be generated based on an event emitted by another service, and/or based on any other suitable information. Examples of service outputs associated with provider events can include: service responses, webhook events, notifications, transfer of data out of a computational routine when a certain point in the execution flow is reached, and/or any other suitable service output or state. The output from the service can be automatically sent by the service (e.g., responsive to completion of a service process), be queried by the provider, and/or otherwise determined.

The provider event object is preferably exposed on the event store, but can alternatively be directly sent to another provider (e.g., provider instance), sent to the coordination system, and/or otherwise communicated to the remainder of the system. The provider can write, publish, and/or otherwise expose the provider event object on the event store (e.g., on a shared event store, on a channel or event store specific to the provider, etc.).

However, the provider events can be otherwise configured and used.

In variants, the system can additionally include other events, which can be emitted by the system (e.g., system start events), auxiliary components (e.g., timers), and/or other events. In operation, the events can be used in the same manner as provider events, as described herein.

The provider actions function to enable system interaction (e.g., control) over the associated service instance. Provider actions can be functions exposed by the providers, and can be invoked responsive to events. For example, the system can call the provider action from the provider, and the provider can translate the provider action call into a service-specific call, wherein the service instance executes the actions (e.g., processes, functions, etc.) associated with the service-specific call. Examples of provider actions can include: start, stop, train, test, query status, and/or any other suitable action.

Each provider can be associated with one or more provider actions, or no provider actions. Each provider in the system preferably has its own set of provider actions, wherein different providers have different provider actions, but can alternatively have the same set of provider actions as other providers.

Each provider action can be associated with one or more service actions (e.g., a single call, a series of calls, etc.) by the provider. Each service action can be associated with one or more provider actions. A provider action can facilitate execution of a service action (e.g., a service process) by: calling a predetermined set of service functions, changing the value of a webhook monitored by the service instance, and/or otherwise facilitating execution of the service action. The manner in which the service action is facilitated is preferably specified by the provider (e.g., wherein the provider defines the series of service calls needed to execute the provider action), but can alternatively be specified by the configuration, by the user (e.g., by service-specific code), and/or otherwise specified. The provider action can be associated with one or more variable values, wherein the variable values can be passed to the service instance for execution. The variable values can be: specified by the provider, provided by the configuration (e.g., in the provider specification), provided by a user (e.g., directly to the service), determined from a shared variable, and/or otherwise determined.

The provider actions for the provider are preferably exposed, such that the action can be triggered by another system (e.g., based on occurrence of a provider event), but can alternatively be hidden (e.g., only used by the provider).

However, the provider actions can be otherwise configured and used.

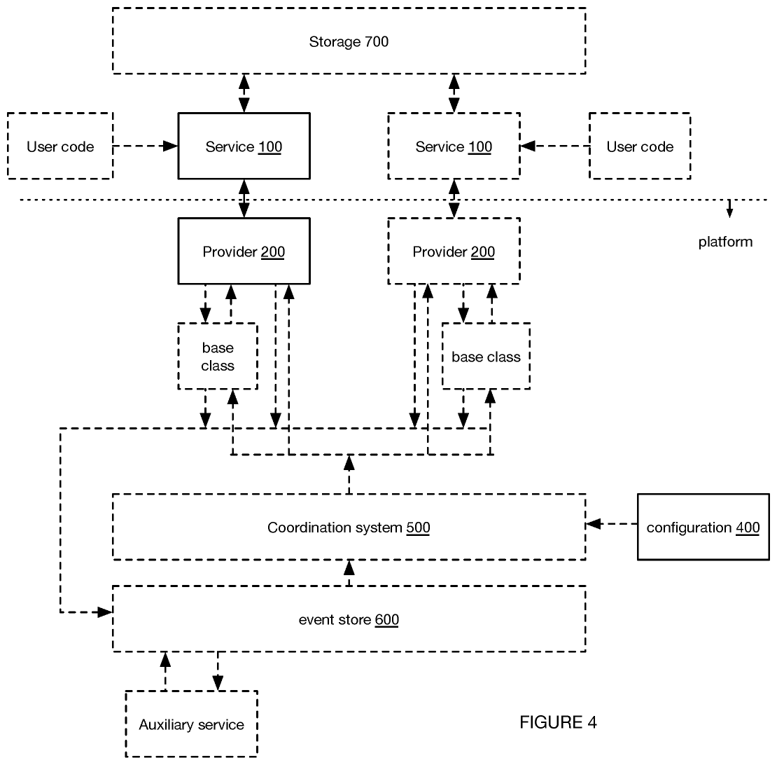

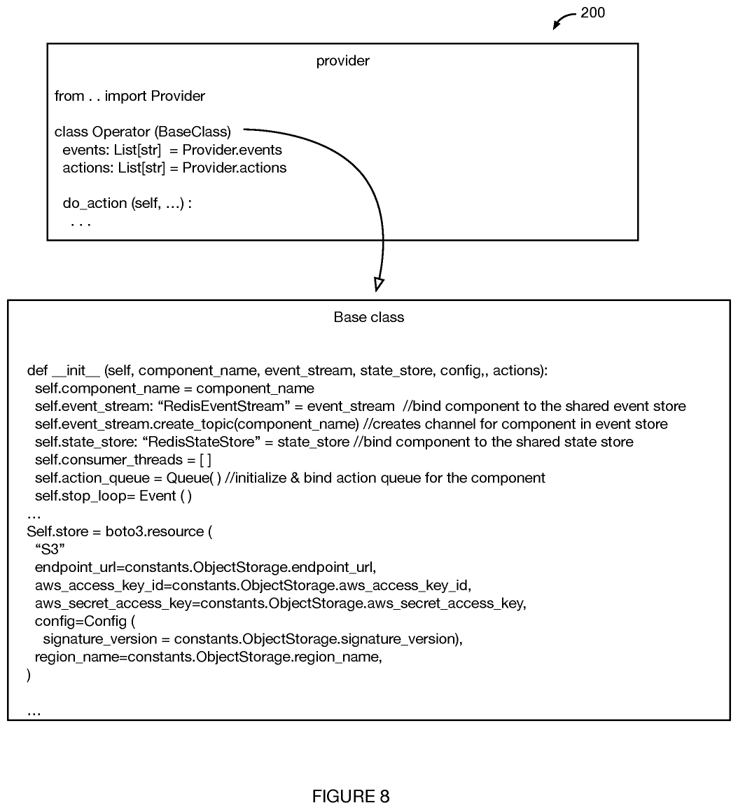

In variants, the system can define a set of standard provider classes (e.g., traits, interfaces, protocols, base classes, component classes, provider types, provider instance type, etc.), wherein some, all, or none of the providers can be associated with (e.g., derived from) one or more provider classes. Each standard provider class can be associated with a set of events and/or a set of actions. The set of events and/or actions can be required, wherein each provider associated with the provider class includes a provider event and provider action for each required event and required action, respectively (e.g., conforms to the provider class; supports the required event and/or action; example shown in FIG. 8). Alternatively, the set of events and/or actions can be optional. In examples, the standard provider class can enable composition or composite reuse (e.g., enable object oriented programming without inheritance), wherein each provider of the standard provider class (e.g., provider of the trait) conforms to the standard provider class' set of events and/or actions, such that other providers can interoperate with the provider (e.g., using a standard set of calls for the events and/or actions). For example, a data source should support data read/write and data segmentation. In another example, a trainer should support training, testing, and validation, and should output a training state. The providers can include more provider events and/or provider actions than those associated with the associated standard provider class. The events and/or actions are preferably referenced by reserved names (e.g., such that the same conceptual service action is executed responsive to an action, and each event is associated with the same conceptual service state), but can alternatively be referenced by different names. The provider class can additionally or alternatively specify a set of data that the provider must expose (e.g., what volume needs to be exposed, such as the artifact directory, model directory, etc.). However, the provider class can be otherwise configured and/or used. The provider class can additionally or alternatively include instructions on how to interact with system components, such as the coordination system, the event store, the secret store, and/or any other suitable component. The instructions can be code or other instructions. For example, the instructions can include a set of calls or functions to publish a provider event to the event stream, or how to receive an action call from the coordination system (e.g., examples shown in FIG. 8 and FIG. 4). However, the standard provider classes can be otherwise defined.

In a first example, the data provider class can be associated with a predetermined set of actions (e.g., do_retrieve) and a predetermined set of event triggers (e.g., on_start, on_end, on_retrieval_start, on_retrieval_end). In a second example, the training provider class can be associated with a predetermined set of action objects (e.g., do_start, do_end) and a predetermined set of event triggers (e.g., on_start, on_end, on_train_start, on_train_failed, on_train_end). In a third example, the model serving provider class can be associated with a predetermined set of actions to perform (e.g., do_start, do_end) and a predetermined set of event triggers (e.g., on_start, on_end, on serve start, on_prediction, on_serve_end). In a fourth example, the integration provider class can be associated with a predetermined set of actions to perform (e.g., do_notify) and a predetermined set of event triggers (e.g, on_start). In a fifth example, a system provider class can be associated with a predetermined set of actions to perform (e.g., do_start, do_end) and a predetermined set of event triggers (e.g., on_start, on_end), wherein the system provider class can represent the coordination system orchestrating inter-service operation. In a sixth example, a ML model training provider class can be associated with a set of required provider parameters (e.g., hyperparameters) and a set of required actions (e.g., train, fit, optimize, validate, test, etc.).

Each provider can be associated with one standard provider class, multiple standard provider classes, and/or any other suitable number of standard provider classes. For example, a service can have two different functionalities (e.g., two different standard provider classes) and the system can include two different provider classes, one for each functionality (e.g., standard provider class). In this example, the provider for the service could be associated with two different provider classes, and include the actions and/or events from each provider class. Alternatively, the system can include two different providers for the same service, one for each provider class. In an illustrative example, the first provider can be for Amazon SageMaker's DataWrangler, wherein the first provider can be associated with a data source standard provider class, and the second provider can be for Amazon SageMaker's DistributedTraining, wherein the second provider can be associated with the trainer standard provider class.

However, the provider classes can be otherwise configured and used.

The system can optionally include a set of integration modules that enable the providers to interact with the remainder of the system components (e.g., the coordination system, event store, secret store, etc.). For example, the integration modules can specify how to configure, deploy, and/or manage an instance of a provider on the system hardware; how to expose events to the event stream; how to access the secret store; how to register with the coordination system, how to respond to the coordination system, and/or define other interactions with system components. The set of integration modules can be: a set of object classes, be integrated into the provider classes, be a set of code that entities can copy into the providers when writing the providers, and/or be otherwise configured.

In operation, the system can generate one or more instances of a given provider (e.g., for a given composition). Each provider instance functions to interact with and/or represent one or more service instances.

The system can be used with one or more configurations 400, which can define how a heterogeneous system (e.g., composition) is composed, and how the composition should react to change. A configuration functions to define relationships between different provider instances. For example, the configuration can define a set of conditions to trigger execution of a given service's action. In a specific example, the configuration can define a set of event triggers from a first set of provider instances that trigger a set of actions for a second set of provider instances. The configuration can additionally or alternatively define relationships between the provider instances and a set of users. For example, the configuration can specify that a manual reviewer should review the model output and provide an approval before a subsequent action from a subsequent provider instance can be taken. The configuration can additionally or alternatively include provider parameters and/or instructions for provisioning the services, configuring the services, managing the lifecycle of the composition and/or service, and/or performing any other suitable set of processes. In variants, the resultant composition can be shared with other users for reuse and/or subsequent customization (e.g., on a configuration store, etc.).

The system can include one configuration, multiple configurations, and/or any other suitable number of configurations (e.g., for one or more users). The configuration can be determined by a user (e.g., authored, composited, created, etc.), automatically determined, and/or otherwise determined. The configuration is preferably in the form of a human and/or machine-readable structured document or file (e.g., YAML document, JSON document), but can additionally and/or alternatively be in the form of a composition specification, a configuration document, a directed acyclic graph (DAG), a tree, a program (e.g., written in any computer programming language), and/or any other suitable composition structure. The configurations can be executed locally or remotely (e.g., without any modification between the two environments). The configuration can be uploaded, retrieved, received from a user, programmed by a user, and/or otherwise determined.

The configuration is preferably written in a syntax or language shared by the providers, but can be written in any other suitable syntax or language. The configuration preferably references the provider parameters, provider actions, provider events, and/or other provider resource, and does not reference service-specific parameters, actions, events, or other service resources. However, the configuration can additionally or alternatively include direct service-specific references.

A configuration can include a set of provider specifications, a set of provider connections, a set of variables, and/or any other suitable element (e.g., example shown in FIG. 9).

The provider specification functions to specify the provider parameter values (e.g., trait values) to be used to create, manage, and interact with the associated service instance. The provider specification is preferably part of the configuration, but can be a separate specification, be a standard definition, and/or be otherwise determined. The provider specification can include values for each of a set of provider parameters. Each provider specification preferably results in creation of a provider instance using said specification, but can alternatively result in creation of multiple provider instances specification said specification, or result in creation of no provider instances using said configuration. In variants, each provider specification can be specific to and/or only known to the respective provider; alternatively, the provider specifications can be known to all providers.

The configuration can include one or more provider specifications for one or more providers. For example, the different provider specifications in the configuration each reference a different provider. In a second example, the configuration can include multiple provider specifications, each referencing the same provider, wherein a different instance of the same provider is created for each provider specification.

In an illustrative example, the configuration can include a set of provider specifications, wherein each provider specification can include: an identifier for the associated provider instance (e.g., component), a provider identifier (e.g., identifying which provider to use for the provider instance) or service identifier (e.g., identifying which provider, associated with the service, to use), values for the provider parameters of the identified provider, and/or other information.

The configuration can additionally or alternatively include a set of provider connections that function to define how the providers should interact with each other and/or how the providers should be composed together. In variants, this can enable complex behaviors between disparate service to be composed together. The set of provider connections can: define provider execution dependencies, define relationships between the events and actions from different providers (e.g., action:event relationships), define a conditional model, and/or otherwise define how the providers should interact with each other. The set of provide connections can optionally define explicit or implicit inter-connection dependencies (e.g., a first set of events and actions must be performed before a subsequent set of events and actions can be performed), or not define any inter-connection dependencies. In variants, the configuration can exclude deployment strategy information, wherein the deployment strategy can be handled by the providers and/or services.

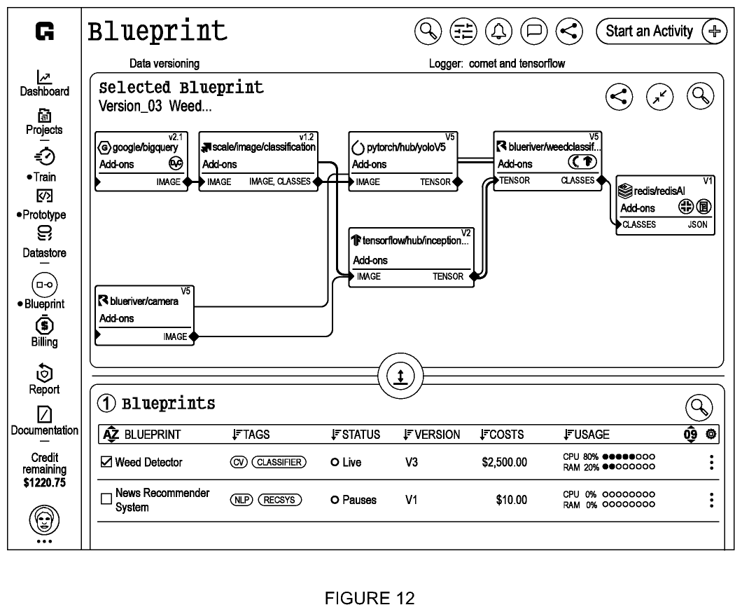

Each provider connection preferably includes a provider event connected to a provider action, but can additionally or alternatively include provider parameter values and/or any other suitable information (e.g., example shown in FIG. 12). Each provider connection preferably connects a single event to a single action, but can alternatively connect one or more events to one or more actions. Provider events are preferably connected to an action from another provider and/or other provider instance, but can alternatively be connected to an action from the same provider and/or same provider instance. The connection is preferably a dependency (e.g., wherein action execution is dependent upon occurrence of the connected event), but can alternatively be any other suitable relationship. The provider events and provider actions are preferably provider events and provider actions from the providers identified in the set of provider specifications, but can additionally or alternatively include provider events and provider actions from providers and/or sources outside of those identified in the set of provider specifications. In a first example, each provider connection only includes provider events and provider actions from the set of providers identified within the set of provider specifications. In a second example, each provider connection can additionally provider parameter values and/or any other suitable information (e.g., wherein the provider action calls can accept variable values).

The set of provider connections can optionally define an execution order for the set of providers. For example, events can only be generated by previously executed providers (e.g., providers from which an action was previously called). The provider connections can be listed in execution order, or not be listed in execution order. Alternatively, the execution order can not be strictly enforced.

All or parts of the set of provider connections can be: manually determined (e.g., graphically, programmatically, etc.), learned, predetermined (e.g., system.on_start is always the first call), and/or otherwise determined. In an example, the connection between provider instances can be built using a graphical user interface (GUI); example shown in FIG. 13. Each provider instance can include an icon for each available event and an icon for each available action. The system can automatically execute the action when the connected event occurs. In another example, the connection between two provider instances can be authored using syntax specifying the connected provider instances and action/event. For example, the connection can be specified as: foo-train.on_end:foo-serve.do_start, wherein the foo-serve.do_start action is performed responsive to the foo-train.on_end event.

The set of variables can function to dynamically communicate data between provider instances (and/or the associated service instances), and can be used to parametrize the configuration specification. The variables are preferably global variables, but can alternatively be specific to a provider and/or be any other suitable variable. The variables can be accessed (e.g., read, edited, etc.) by different provider instances, by different service instances, by the coordination system, and/or by any other suitable component. The variables can be assigned as values to the provider parameters, passed as an provider action variable, or otherwise used. Values can be bound to the variables by any provider instance, by a limited set of provider instance, be manually assigned (e.g., overridden or assigned in a user interface), and/or by any other suitable set of provider instances. Additionally or alternatively, the variables can include secret variables or environment variables that identify a secret within the secret store, such that the secret does not need to be revealed in cleartext. The secrets can be received from a user, received from a provider instance, received from a service instance, generated by the system (e.g., using a cryptographic protocol), and/or otherwise determined. The secret variables can be identified using special syntax (e.g., “env.providerlD . . . ”, etc.), or otherwise identified. The variables can be referenced using the same syntax as that used for provider parameters, or be referenced using different syntaxes.

However, the configuration can be otherwise defined.

The coordination system 500 functions to orchestrate inter-service operation. The coordination system 500 preferably coordinates inter-service operation, via the provider instances, according to the set of provider connections (e.g., by calling the actions from the respective provider, responsive to occurrence of the connected event from the respective provider), but can alternatively coordinate inter-service operation based on a predetermined set of coordination rules, and/or otherwise coordinate inter-service operation.

In variants, the coordination system can coordinate inter-service operation by: detecting events output by provider instances (e.g., by monitoring the event store), identifying the actions and provider instances associated with (e.g., connected to) the detected events, and calling the actions from the respective provider instances. The coordination system can optionally create provider instances, create service instances (e.g., via the provider instances), generate event triggers, detect and mitigate provider failures, and/or perform other functionalities. In variants, the coordination system can be limited to identifying the provider events and calling provider actions, and can be blind to the system instance configurations (e.g., wherein the configurations are handled by the respective provider instances). Alternatively, the coordination system can have knowledge of system instance configurations and/or have other functionalities.

The system can include one coordination system, multiple coordination systems, and/or any other suitable number of coordination systems. The coordination system can be stored locally, remotely, and/or otherwise stored.

The event store 600 functions to store events from the providers (e.g., provider instances). The system can include one or more event stores 600. The system can include one or more event stores for each composition, or include a single event store shared across compositions. The event store can be: an event stream, a queue, a buffer, and/or any other suitable memory space.

The system can additionally or alternatively be used with auxiliary provider instances and/or auxiliary services, such as model repositories, computing environments, artifact storage (e.g., storing trained models, model outputs, etc.), and/or other computing resources. These computing resources are preferably external to the platform and controlled by the user (e.g., wherein the user holds the access credentials to the accounts, wherein the provider instances are executing on user-controlled hardware, etc.), but can alternatively be controlled by the platform or any other suitable system. These resources are preferably used by the service instances, wherein the resource identifiers (and optionally the access credentials) can be specified in the provider instance calling the provider that calls the service instance.

However, the system can include any other suitable component.

### 4. Method.

The method can include: determining a configuration S100 and executing the configuration S200. Executing the configuration S200 can include: optionally initializing the composition, executing an action S300, detecting an event S400; determining a subsequent provider action associated with the event S500; optionally repeating S300-S500 for the subsequent provider action Shoo; and optionally providing an output to an endpoint S700.

4.1. Determining a configuration S100.

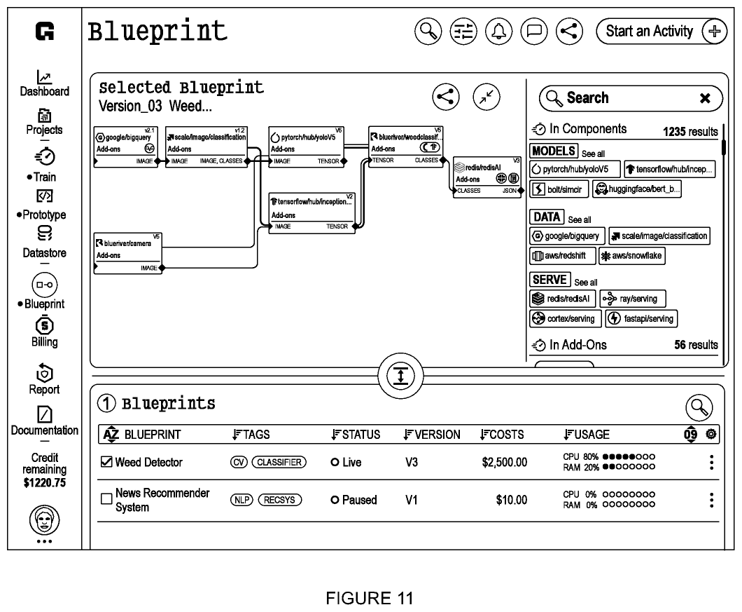

Determining a configuration S100 functions to determine a set of provider specifications and/or determine a set of provider connections. The configuration can be automatically determined (e.g., retrieved from memory, generated from a template, etc.), manually specified (e.g., in a GUI, in a script editor, etc.), and/or otherwise determined. In a first variant, the configuration can be retrieved from one or more human and/or machine-readable structured documents (e.g., YAML document, JSON document). In a second variant, the configuration can be written directly on an interface (e.g., YAML editor) by a user; example shown in FIG. 11 and FIG. X. For example, a user can specify the provider parameter values for each provider and specify the action:event relationships between different providers in the set of provider specifications. In a third variant, the configuration can be built interactively on a GUI (e.g., wherein blocks representing providers can be dragged and dropped into a workspace) by a user. In this variant, the provider parameter values can be automatically specified, specified in another interface, specified using a graphical interface (e.g., wherein values, such as URLs, can be represented by icons or alphanumeric strings), and/or otherwise specified. In a fourth variant, the user can specify an endpoint composition within a predefined configuration (e.g., by specifying an endpoint event, endpoint output, etc.), wherein S100 can include identifying all the parent providers that the endpoint composition is dependent upon. In a fifth variant, the configuration can be learned or automatically generated. For example, the configuration can be automatically generated from an architectural diagram, wherein providers corresponding to the services can be automatically identified, connections between the providers can be automatically generated based on the connections between the services, and the action:event relationships can be inferred (e.g., according to a set of heuristics), extracted from the architectural diagram, and/or otherwise determined. In a sixth variant, the configuration can be generated from a template configuration (e.g., wherein provider parameter values can be manually or automatically modified). However, the configuration can be otherwise determined.

### 4.2. Executing the Configuration S200.

Executing the configuration S200 functions to construct and operate the service instances of the composition, according to the configuration. S200 is preferably performed by the coordination system, but can alternatively be performed by the providers, by the service, and/or otherwise performed. S200 is preferably performed responsive to a request to execute the configuration (e.g., system.start), but can be performed responsive to occurrence of a predetermined event (e.g., a service event), iteratively performed, performed at a predetermined frequency, and/or be performed at any other suitable time.

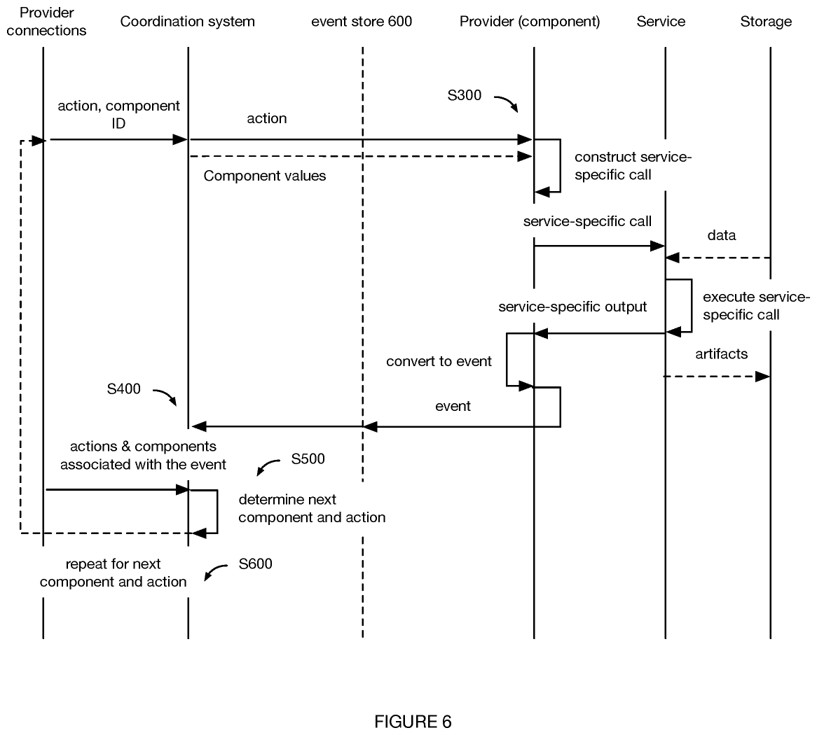

S200 can include: optionally initializing the composition, executing an action S300, detecting an event S400; determining a subsequent provider action associated with the event S500; optionally repeating S300-S500 for the subsequent provider action S600, and optionally providing an output to an endpoint S700 (example shown in FIG. 6). However, the configuration and/or composition can be otherwise executed.

Initializing the composition functions to create the components of the composition. The composition is preferably initialized once, but can alternatively be initialized multiple times. The composition components can all be initialized at the same time, initialized when the composition component is initially used (e.g., called), initialized each time the composition component is used, and/or at any other suitable time. Initializing the composition can include: configuring each composition component, provisioning each composition component, deploying the composition component, and/or otherwise creating a composition component. A composition component can include: an instance of a provider (e.g., provider instance), an instance of a service (e.g., service instance), a coordination system instance, an event stream, and/or any other suitable component.

Initializing the composition preferably includes initializing the provider instances, initializing the service instances, and/or initializing any other suitable composition component.

A different provider instance is preferably initialized for each provider specification within the configuration; alternatively, multiple provider instances or no provider instances can be initialized for each provider specification. Initializing the provider instances can include creating an instance of the provider referenced in the respective provider specification and configuring the provider instance based on the provider parameter values within the provider specification, or otherwise initializing the provider instance. The provider instance is preferably initialized by the coordination system, but can additionally or alternatively be initialized by the platform, a service instance, and/or by any other suitable component.

A service instance is preferably initialized for each provider instance; alternatively, multiple service instances or no service instances can be initialized for each provider instance. The service instance is preferably initialized on the respective service, but can alternatively be initialized on the platform or on any other suitable service or computing system. The service instance is preferably initialized by the respective provider instance, but can additionally or alternatively be initialized by the provider, by the user (e.g., wherein the service instance identifier is passed to the composition or provider instance), by the coordination system, and/or by any other suitable system. The service instance can be initialized using: the provider parameter values (e.g., from the provider instance, from the respective provider specification, etc.), user credentials for the service (e.g., stored in the secret store, accessed by the provider instance, etc.), and/or any other suitable information. In an example, a provider instance can construct a set of service instance initialization calls based on templates provided in the provider and the provider parameter values, and interact with the service (e.g., via a service interface) to create the service instance. Service instance information (e.g., service instance identifier, session credentials, tokens, etc.) can optionally be returned to the provider instance, wherein the provider instance can expose the service instance information on the event store, store the service instance information to platform storage (e.g., shared storage), and/or otherwise manage the service instance information.

Executing an action from a provider S300 functions to cause an external service to execute an action. S300 can be performed by the provider (e.g., identified by the provider instance), by the coordination system (e.g., wherein the coordination system calls the provider and/or provider instance), and/or otherwise performed. S300 can be performed when the action is determined (e.g., in S500), when a connected preceding or trigger event is detected, be performed periodically, and/or be performed at any other suitable time. The provider action can be the action called from the provider, be the subsequent action associated with an event (e.g., determined in S500), be an initial action call, be an initial action call associated with an initial event (e.g., a system_start event), and/or be any other suitable provider action call.

In variants, S300 can include: receiving a provider action call; determining a set of service calls (e.g., API calls, etc.) associated with the provider action (e.g., converting the action to a set of service-specific calls); and implementing the set of service calls using the associated service instance (e.g., by calling the set of service calls); example shown in FIG. 5. S300 can optionally include receiving a service response (e.g., determining a service state), and emitting a provider event associated with the service response.

The provider action call is preferably received by the provider exposing or defining the provider action call, but can alternatively be received by any other suitable system. The provider action call is preferably received from the coordination system, but can alternatively be received from another provider, from a service instance, from the event stream, and/or from any other suitable source.

The set of service calls is preferably predetermined, but can alternatively be dynamically determined. In an example, the provider can define: the service calls associated with the action, the order in which to call the service calls, the call conditions (e.g., when to call the service calls), the completion conditions (e.g., when a preceding service call is complete), and/or any other suitable service-specific information. The service calls can additionally or alternatively include provider parameter values. The provider parameter values can be: passed as part of the provider action call; be retrieved by the provider from shared storage (e.g., a secret store, platform storage, etc.); be determined from the provider parameter values within the configuration; be determined from the provider instance (e.g., wherein the provider instance stores the provider parameter values); and/or otherwise determined. The provider parameter values can optionally be mapped to service variable values, wherein the service variable values are used in the call.

Implementing the set of service calls can include: determining the service instance associated with the provider (e.g., the provider instance) and sending the set of service calls to the service instance. The service instance can execute the service calls, and optionally return a set of responses or outputs to the provider instance. The service instance can optionally store outputs to the storage 700, and optionally return output identifiers (e.g., filepaths) to the system (e.g., the provider instance). The provider instance can then convert the set of responses or outputs into provider events, and optionally expose the events to the event store. The emitted event can be associated with the provider instance associated with the source service instance, or otherwise identified. Alternatively, the service instance can directly write the responses or outputs to the event store.

In a specific example, the provider receives the action call, determines the associated set of service actions, and controls the associated service instance to execute the set of service actions.

However, S300 can be otherwise performed.

Detecting an event S400 functions to detect triggers for downstream provider instance actions, and can optionally determine the state of a service instance. The event can be detected by the coordination system (e.g., wherein the coordination system subscribes to an event store or monitors the provider or provider instance outputs), a provider, the service, and/or detected by any other suitable component. The event can include: a single event associated with a single provider instance, multiple events associated with multiple provider instances (e.g., a composite event), and/or any other suitable number of events. The event can be: a provider event (e.g., representative of a predetermined state of the associated service), an initial event (e.g., generated by the coordination system, generated by a special initial component for each composition, etc.), an event emitted by auxiliary components (e.g., timers, sensors, etc.), and/or be any other suitable event. The event can be emitted by and/or associated with: a provider (e.g., provider instance), a service (e.g., service instance), a timer, an external data source (e.g., using a call to the external data source, via a callback or webhook for the external data source, etc.), and/or by any other suitable data source. The event can be detected by: monitoring the event store for the event, monitoring the provider instance, monitoring the service instance, and/or otherwise detecting the event.

In a first variant, S400 includes monitoring the event store for the set of provider events specified within the set of provider connections (e.g., with the coordination system). In an embodiment, the system can then perform S500 for the detected event. In a first example, the coordination system detects a single event on the event stream. In a second example, the coordination system waits until all events within a composite event appear within the event store before performing S300 for the associated action(s).

In a second variant, a provider instance detects the event by monitoring the event stream or the source provider for the event. In this variant, each provider instance can be provided with a set of provider events (e.g., including the source provider and the events) associated with the respective provider instance's actions. The set of provider events associated with the respective provider instance's actions can be determined from the configuration (e.g., the set of provider connections) and/or otherwise determined.

In a third variant, detecting the event can include (e.g., by a provider): receiving a service-specific event from the service, converting the service-specific event to a provider event, and emitting the provider event. Alternatively, the system (e.g., the provider, the coordination system, etc.) can receive an output from the service and generate a predetermined event—associated with the service output—responsive to output receipt.

However, the event can be otherwise determined.

Determining a subsequent provider action associated with the event S500 functions to identify and execute the next action on the next service by identifying and executing the next action on the next provider. S500 is preferably performed when the event is detected, but can be performed before or at any other time. S500 can be performed by the coordination system, by the provider instance, and/or performed by any other suitable system. For example, the coordination system can identify the subsequent provider instance and action, and call the action on the provider instance. The subsequent provider action (e.g., next provider action) can be determined: from the configuration (e.g., based on the set of provider connections; be the next provider instance and action connected to the event and/or the provider instance from S300), from the source provider's specification (e.g., based on a hard-coded event-action dependency), and/or otherwise determined. The determined provider action can include: which action to call, the provider instance that the action should be called from (e.g., subsequent provider instance), provider parameter values (e.g., from the configuration, from the set of provider connections, from the provider specification for the subsequent provider instance, etc.), and/or any other action information. The subsequent provider instance is preferably a different provider instance from the provider instance generating the event in S300 (e.g., associated with a different provider or service; associated with different provider parameter values; etc.), but can alternatively be the same. In an example, S500 can include determining a connection associated with the event (e.g., from a first provider) from the set of provider connections, determining the action from the second provider based on the connection, and calling the action from the second provider.

In an illustrative example, the action of the foo-serve provider instance can be invoked in response to detection of an event of the foo-train provider instance, wherein the foo-serve provider instance will start executing when the foo-train provider instance outputs a predetermined event (e.g., finishes execution). The trigger can be represented in the syntax form: foo-train.on_end: foo-serve.do_start. However, determining the subsequent provider action can be otherwise performed.

Repeating S300-S500 for the subsequent provider action S600 functions to continue data processing using the heterogeneous services. S600 is preferably coordinated by the coordination system, but can alternatively be coordinated by a parent provider instance, by the subsequent provider instance, by the set of provider instances, by the service instances, and/or any other suitable component. S600 is preferably iteratively repeated until a stop condition is met, but can be otherwise terminated. The stop condition can be: detection of a predetermined output or event (e.g., a user-specified stopping point, a failure event, etc.), determination that no subsequent provider actions exist, and/or any other suitable stop condition. However, S600 can be otherwise performed.

The method can optionally include providing an output to an endpoint S700, which functions to return an output to the user or entity executing the configuration. The output can be: a system output, a composition output (e.g., a service output, etc.), and/or any other suitable output. The output can be provided by: the system, a service, or by any other component. In a first variant, S700 can include providing the status of the configuration to the user on an interface. The status can be: pending (e.g., during provisioning computing resources and deploying runtime provider instances), running (e.g., when provider instances are in place and operational), complete (e.g., when execution of configuration is complete), and/or any other suitable status. In a second variant, S700 can include notifying the user that the service outputs (e.g., models, artifacts, logs etc.) are available on the respective services and/or the storage 700. In a third variant, S700 can include: providing the output or a reference thereto to the endpoint, providing the final event to the endpoint, providing a notification to the endpoint, and/or providing any other suitable output to the endpoint. However, S700 can be otherwise performed.

Different subsystems and/or modules discussed above can be operated and controlled by the same or different entities. In the latter variants, different subsystems can communicate via: APIs (e.g., using API requests and responses, API keys, etc.), requests, and/or other communication channels.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable instances integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable instance can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system instances and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A system comprising:
a set of service modules, each associated with a third party service, wherein each service module defines a set of traits, a set of actions, and a set of events specific to the respective third party service;
an event stream, wherein the service modules publish events to the event stream; and
an execution system, configured to:
receive a configuration defining a set of connections between events from the set of service modules and actions from the set of service modules; and
coordinate interactions between the third party services associated with each service module of the set, based on the set of connections.

2. The system of claim 1, wherein the configuration is received from a user, wherein different users are associated with different configurations.

3. The system of claim 1, wherein the events are generated based on responses from the respective third party service.

4. The system of claim 1, wherein the configuration defines trait values for each of the set of service modules.

5. The system of claim 4, wherein the trait values comprise a reference to data storage shared between the third party services.

6. The system of claim 5, wherein the reference is bound to a global variable shared between the respective service modules, wherein the trait value is bound to the global variable.

7. The system of claim 1, wherein each service module is associated with a standard provider class from a set of standard provider classes, wherein each standard provider class is associated with a predetermined set of actions and a predetermined set of events.

8. The system of claim 1, wherein the configuration further defines values for traits for each of the set of service modules.

9. The system of claim 8, wherein a service module controls provisioning of an instance of the respective third party service based on the values for the respective traits.

10. The system of claim 1, wherein a third party service associated with a service module is a machine learning service or a collaboration service.

11. The system of claim 1, wherein a third party service associated with a service module is a cloud computing provider.

12. The system of claim 1, wherein coordinating interactions between the set of third party services comprises:
monitoring the event stream for an event from a first service module;
determining a connection between the event and an action from a second service module based on the set of connections within the configuration; and
calling the action from the second event module when the event is detected within the event stream, wherein the second event module translates the action call into an instruction specific to the respective third party service.

13. The system of claim 1, wherein a third party service associated with a service module of the set stores execution artifacts in shared storage, wherein the execution artifacts are generated by the third party service through execution of a process associated with an action defined by the respective service module.

14. The system of claim 13, wherein the shared storage is accessible by a second third party service, wherein a reference to the shared storage is bound to a global variable that is passed as a trait to the service module for the second third party service.

15. A method comprising:
determining a configuration comprising:
a set of service module identifiers identifying a set of service modules, wherein each service module comprises a set of events and a set of actions and is associated with a different third party service; and
a set of connections between events and actions from the set of service modules;
detecting an event from a first service module of the set;
determining a connection between the event from the first service module and an action of a second service module of the set, based on the set of connections; and
calling the action of the second service module when the event is detected, wherein the third party service associated with the second service module executes a process associated with the action.

16. The method of claim 15, wherein detecting the event comprises: monitoring an event stream for the event from the first service module, wherein the first service module exposes events from the respective third party service on the event stream.

17. The method of claim 15, wherein the configuration further comprises a global variable shared between the set of service modules, wherein a value bound to the global variable is editable by different service modules of the set.

18. The method of claim 15, wherein each service module further comprises a set of configuration parameters, wherein the configuration further defines a value for each configuration parameter of the set of configuration parameters for each service module of the set of service modules, and wherein the method further comprises provisioning a set of third party instances, each corresponding to a service module of the set, based on the respective configuration parameter values.

19. The method of claim 18, further comprising storing credentials for each third party service, wherein the set of third party instances are provisioned using the credentials.

20. The method of claim 19, wherein the configuration is received from a user, wherein the credentials comprise credentials for the user for each third party service.
